(19) United States
(12) Patent Application Publication
(10) Pub. No.: US 2014/0270575 A1
(43) Pub. Date: Sep. 18, 2014

(54) METHODS AND SYSTEMS FOR CAPTURE PROCESSING

(71) Applicant: Concur Technologies, Inc., Bellevue, WA (US)

(72) Inventors: Manish RAJKARNIKAR, Woodbury, MN (US); Sabirhusain Nazirhusain PATEL, Rosemount, MN (US); Andrew DOTSON, Minneapolis, MN (US); Michael FREDERICKS, Farifax, VA (US)

(73) Assignee: Concur Technologies, Inc., Bellevue, WA (US)

(21) Appl. No.: 14/213,523

(22) Filed: Mar. 14, 2014

Related U.S. Application Data
(63) Continuation-in-part of application No. 14/188,414, filed on Feb. 24, 2014.
Application No. 14/188,414 is a continuation of application No. 13/602,589, filed on Sep. 4, 2012, now Pat. No. 8,712,811.
Application No. 13/602,589 is a continuation-in-part of application No. 13/593,108, filed on Aug. 23, 2012.
Application No. 13/602,589 is a continuation-in-part of application No. 13/277,923, filed on Oct. 20, 2011, now Pat. No. 8,620,750.
Application No. 13/602,589 is a continuation-in-part of application No. 13/277,916, filed on Oct. 20, 2011.
Application No. 13/602,589 is a continuation-in-part of application No. 12/901,947, filed on Oct. 11, 2010.
Application No. 13/602,589 is a continuation-in-part of application No. 12/773,282, filed on May 4, 2010.
Application No. 13/602,589 is a continuation-in-part of application No. 11/763,562, filed on Jun. 15, 2007.
Application No. 11/763,562 is a continuation of application No. 10/270,672, filed on Oct. 16, 2002, now abandoned.
Application No. 13/602,589 is a continuation-in-part of application No. 13/396,255, filed on Feb. 14, 2012.
Application No. 13/396,255 is a continuation of application No. 12/755,127, filed on Apr. 6, 2010, now Pat. No. 8,140,361.
Application No. 12/755,127 is a continuation of application No. 10/373,096, filed on Feb. 26, 2003, now Pat. No. 7,720,702.
Application No. 13/602,589 is a continuation-in-part of application No. 13/117,303, filed on May 27, 2011.
Application No. 13/117,303 is a continuation of application No. 11/159,398, filed on Jun. 23, 2005, now Pat. No. 7,974,892.
Application No. 11/159,398 is a continuation-in-part of application No. 14/036,320, filed on Sep. 25, 2013.
Application No. 14/036,320 is a continuation-in-part of application No. 13/830,319, filed on Mar. 14, 2013.
Application No. 13/830,319 is a continuation of application No. 13/712,614, filed on Dec. 12, 2012.
Application No. 14/036,320 is a continuation-in-part of application No. 13/830,410, filed on Mar. 14, 2013.
Application No. 13/830,410 is a continuation of application No. 13/712,629, filed on Dec. 12, 2012.
Application No. 13/712,629 is a continuation-in-part of application No. 13/606,494, filed on Sep. 7, 2012.
Application No. 13/606,494 is a continuation-in-part of application No. 13/602,589, filed on Sep. 4, 2012, now Pat. No. 8,712,811.
Application No. 13/602,589 is a continuation-in-part of application No. 13/842,913, filed on Mar. 15, 2013.
Application No. 13/842,913 is a continuation-in-part of application No. 13/593,108, filed on Aug. 23, 2012.
Application No. 13/842,913 is a continuation-in-part of application No. 13/396,255, filed on Feb. 14, 2012.
Application No. 13/396,255 is a continuation-in-part of application No. 14/060,960, filed on Oct. 23, 2013.
Application No. 14/060,960 is a continuation of application No. 13/277,923, filed on Oct. 20, 2011, now Pat. No. 8,620,750.
(60) Provisional application No. 61/799,984, filed on Mar. 15, 2013.
(60) Provisional application No. 61/799,771, filed on Mar. 15, 2013.
(60) Provisional application No. 61/569,942, filed on Dec. 13, 2011.
(60) Provisional application No. 61/569,949, filed on Dec. 13, 2011.
(60) Provisional application No. 61/529,680, filed on Aug. 31, 2011.
(60) Provisional application No. 61/405,480, filed on Oct. 21, 2010.
(60) Provisional application No. 61/405,488, filed on Oct. 21, 2010.
(60) Provisional application No. 61/405,480, filed on Oct. 21, 2010.
(60) Provisional application No. 61/405,488, filed on Oct. 21, 2010.
(60) Provisional application No. 61/324,533, filed on Apr. 15, 2010.
(60) Provisional application No. 61/324,533, filed on Apr. 15, 2010.
(60) Provisional application No. 60/329,281, filed on Oct. 16, 2001.
(60) Provisional application No. 60/581,766, filed on Jun. 23, 2004.
(60) Provisional application No. 61/705,265, filed on Sep. 25, 2012.
(60) Provisional application No. 61/569,942, filed on Dec. 13, 2011.
(60) Provisional application No. 61/569,949, filed on Dec. 13, 2011.
(60) Provisional application No. 61/705,265, filed on Sep. 25, 2012.
(60) Provisional application No. 61/569,942, filed on Dec. 13, 2011.
(60) Provisional application No. 61/569,949, filed on Dec. 13, 2011.
(60) Provisional application No. 61/705,265, filed on Sep. 25, 2012.
(60) Provisional application No. 61/529,680, filed on Aug. 31, 2011.

(51) Int. Cl. G06K 9/72

(52) U.S. Cl. CPC G06K 9/72
USPC 382/321

(57) ABSTRACT

Systems and methods may perform processing associated with receiving, with a capture module in communication with a processor, data. Processing may be performed associated with converting, with an optical character recognition (OCR) module in communication with the capture module and the processor, the data into machine readable data. Processing may be performed associated with extracting, with a processing module in communication with the OCR module and the processor, relevant data from the machine readable data. Processing may be performed associated with populating, with the processing module, a field in a report with the relevant data.

### CROSS-REFERENCE TO RELATED APPLICATIONS

This application claims the benefit of U.S. Provisional Application No. 61/799,984, filed Mar. 15, 2013 and 61/799,771, filed Mar. 15, 2013. This application is also a continuation-in-part of U.S. patent application Ser. No. 14/188,414, filed Feb. 24, 2014, which is a continuation of U.S. patent application Ser. No. 13/602,589 filed Sep. 4, 2012, which claims the benefit of U.S. Provisional Application Nos. 61/569,942, filed Dec. 13, 2011, and 61/569,949, filed Dec. 13, 2011. U.S. patent application Ser. No. 13/602,589 is also a Continuation-in-Part of U.S. patent application Ser. No. 13/593,108, filed Aug. 23, 2012, which claims the benefit of U.S. Provisional Application No. 61/529,680, filed Aug. 31, 2011. U.S. patent application Ser. No. 13/602,589 is also a Continuation-in-Part of U.S. patent application Ser. No. 13/277,923, filed Oct. 20, 2011 (now U.S. Pat. No. 8,620,750 issued Dec. 31, 2013), which claims the benefit of U.S. Provisional Application Nos. 61/405,480, filed Oct. 21, 2010, and 61/405,488, filed Oct. 21, 2010. U.S. patent application Ser. No. 13/602,589 is also a Continuation-in-Part of U.S. patent application Ser. No. 13/277,916, filed Oct. 20, 2011, which claims the benefit of U.S. Provisional Application Nos. 61/405,480, filed Oct. 21, 2010, and 61/405,488, filed Oct. 21, 2010. U.S. patent application Ser. No. 13/602,589 is also a Continuation-in-Part of U.S. patent application Ser. No. 12/901,947, filed Oct. 11, 2010, which claims the benefit of U.S. Provisional Application No. 61/324,533, filed Apr. 15, 2010. U.S. patent application Ser. No. 13/602,589 is also a Continuation-in-Part of U.S. patent application Ser. No. 12/773,282, filed May 4, 2010, which claims the benefit of U.S. Provisional Application No. 61/324,533, filed Apr. 15, 2010. U.S. patent application Ser. No. 13/602,589 is also a Continuation-in-Part of U.S. patent application Ser. No. 11/763,562, filed Jun. 15, 2007, which is a Continuation of U.S. patent application Ser. No. 10/270,672, filed Oct. 16, 2002 (now abandoned), which claims the benefit of U.S. Provisional Application No. 60/329,281, filed Oct. 16, 2001. U.S. patent application Ser. No. 13/602,589 is also a Continuation-in-Part of U.S. patent application Ser. No. 13/396,255, filed Feb. 14, 2012, which is a Continuation of U.S. patent application Ser. No. 12/755,127, filed Apr. 6, 2010 (now U.S. Pat. No. 8,140,361 issued Mar. 20, 2012), which is a Continuation of U.S. patent application Ser. No. 10/373,096, filed Feb. 26, 2003 (now U.S. Pat. No. 7,720,702 issued May 18, 2010). U.S. patent application Ser. No. 13/602,589 is also a Continuation-in-Part of U.S. patent application Ser. No. 13/117,303, filed May 27, 2011, which is a Continuation of U.S. patent application Ser. No. 11/159,398, filed Jun. 23, 2005 (now U.S. Pat. No. 7,974,892 issued Jul. 5, 2011), which claims the benefit of U.S. Provisional Application No. 60/581,766, filed Jun. 23, 2004. This application is also a continuation-in-part of U.S. patent application Ser. No. 14/036,320 filed Sep. 25, 2013, which claims priority to U.S. Provisional Application No. 61/705,265, filed Sep. 25, 2012. U.S. patent application Ser. No. 14/036,320 is also a Continuation-in-Part of U.S. patent application Ser. No. 13/830,319, filed Mar. 14, 2013, which, in turn, is a Continuation of U.S. patent application Ser. No. 13/712,614, filed Dec. 12, 2012, which claims the benefit of U.S. Provisional Application Nos. 61/569,942, filed Dec. 13, 2011, 61/569,949, filed Dec. 13, 2011, and 61/705,265, filed Sep. 25, 2012. U.S. patent application Ser. No. 14/036,320 is also a Continuation-in-Part of U.S. patent application Ser. No. 13/830,410, filed Mar. 14, 2013, which is a Continuation of U.S. patent application Ser. No. 13/712,629, filed Dec. 12, 2012, which claims the benefit of U.S. Provisional Application Nos. 61/569,942, filed Dec. 13, 2011, 61/569,949, filed Dec. 13, 2011, and 61/705,265, filed Sep. 25, 2012. U.S. patent application Ser. No. 13/712,629 is also a Continuation-in-Part of U.S. patent application Ser. No. 13/606,494, filed Sep. 7, 2012. U.S. patent application Ser. No. 13/712,629 is also a Continuation-in-Part of U.S. patent application Ser. No. 13/602,589, filed Sep. 4, 2012. This application is a continuation in part of U.S. patent application Ser. No. 13/842,913 filed Mar. 15, 2013, which is a continuation in part of U.S. patent application Ser. No. 13/593,108, filed Aug. 23, 2012 which claims the benefit of U.S. Provisional Application No. 61/529,680, filed Aug. 31, 2011. U.S. patent application Ser. No. 13/842,913 is also a continuation in part of U.S. patent application Ser. No. 13/396,255 filed Feb. 14, 2012. This application is a continuation in part of U.S. patent application Ser. No. 14/060,960 filed Oct. 23, 2013, which is a continuation of U.S. patent application Ser. No. 13/277,923 filed Oct. 20, 2011 (now U.S. Pat. No. 8,620,750 issued Dec. 31, 2013). All of the foregoing are incorporated by reference in their entireties for all purposes.

This application is also related to U.S. patent application Ser. No. 11/774,489, filed Jul. 6, 2007 (now abandoned), which is incorporated by reference in its entirety for all purposes.

### BRIEF DESCRIPTION OF THE DRAWINGS

FIG. 1 is a network according to an embodiment of the invention.

FIG. 2 is a capture processing method according to an embodiment of the invention.

FIG. 3 is an email capture processing method according to an embodiment of the invention.

### DETAILED DESCRIPTION OF SEVERAL EMBODIMENTS

Systems and methods described herein may capture and process data such as invoice data. For example, a buyer may receive an invoice from a seller via an email or other communication medium. In another example, a paper invoice may be received. The invoice may be captured and processed. Data contained within the invoice may be extracted for use and/or analysis. For example, the data may be added to an expense system to enable tracking, review, payment, or other activities. While the examples described herein are presented in the context of invoice tracking, the capture processing systems and methods may be used with other types of data as well.

Systems and methods described herein may comprise one or more computers. A computer may be any programmable machine or combination of programmable machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. For example, though the term “server” may appear in the following specification, the disclosed embodiments are not limited to servers.

Computers may be linked to one another via a network or networks. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via Wi-Fi, WiMax, or other wireless connection). Connections between computers may use any protocols, including connection oriented protocols such as TCP or connectionless protocols such as UDP. Any connection through which at least two computers may exchange data can be the basis of a network.

FIG. 1 is a network 100 according to an embodiment of the invention. The network may include a capture processing system 110 which may include one or more computers. The capture processing system 110 may include a capture module 120 which may receive an invoice, an optical character recognition (OCR) module 140 which may process the invoice to convert it to data which may be machine readable and/or editable, and a processing module 130 which may further process the converted data. The functions of these modules are described in greater detail below. Also note that in some cases, one or more of the modules may be elements of another computer system in communication with the capture processing system 110. For example, an OCR module 140 may be provided by a third party computer in some embodiments.

The capture processing system 110 may be connected to one or more networks 150, such as a public internet or private intranet, through which the capture processing system 110 may receive invoice data (for example via email). However, in some embodiments the capture processing system 110 may be a standalone system as well (for example, if all invoices are being entered from paper sources, there may be no need to receive invoices via email). The capture processing system 110 may also be directly connected to one or more other computers 160, through which the capture processing system may receive invoices. Also, other computers 160 may be in communication with the network 150 and may send invoice data to the capture processing system 110 via the network.

The capture processing system 110 may capture invoice data and may categorize and/or route the invoice for review and/or processing based on the captured data. The capture processing system 110 may gather information and context about invoices at multiple points in time. Thus, after a first invoice is captured and fields are populated a certain way, a second invoice captured may have similar fields automatically populated in a similar way. The OCR module 140 may process the captured invoice soon after the invoice is captured by the capture module 120, for example within a minute, so that the data may be made available to a user quickly. If a paper invoice is received, as those invoices are scanned and uploaded, the processing module 130 may choose any field known about the invoice for processing. For example, a processing department of a company might know that all invoices sent a particular PO box are for a specific department. They might know that all invoices received in the UK require VAT processing. They might know a specific batch is all US Dollars. The processing module 130 may gather one or more configurable fields of interest, such as fields related to any of the examples above. The processing module 130 may also gather information on email invoices such as the from: address or an image name that might indicate information about the invoice.

The processing module 130 may use information previously processed by the capture processing system 110 to help it achieve better accuracy. For example, words and phrases which may be known to be of interest by a user (e.g., VAT, PO, Department, GL Coding, etc.) may be detected by the OCR module 140. When the OCR module 140 sends invoice data including such words and phrases of interest to the processing module 130 for a first time, the processing module 130 may not already know to place the data associated with the words and phrases into an appropriate field in an expense report, for example. In some cases, this may be because a field for such words and phrases has not yet been created in the processing module 130. However, as users reviewing expense reports in the processing module 130 repeatedly place data associated with “PO” into an address field, for example, the processing module 130 may identify the association between “PO” and address. The processing module 130 may use this identified association to automatically populate a field with data related to the identified association in future processing (for example, populate an address field with “PO” related data). Likewise, if a new field is created and data associated with a certain word or phrase is placed into that field, the processing module 130 may place similar data into that field in a future processing step. The capture processing system 110 may also allow the fields to be configured and/or reconfigured by users so that the processing module 130′s processing may be tailored to the requirements of a particular user or business.

In some cases, invoices and expense reports may be subject to the requirements of company policies. The processing module 130 may be configured to perform its processing based on applicable policies. For example, the processing module 130 may search for certain data in the OCR processed invoice based on a policy, the processing module 130 may populate certain fields in a report based on a policy, determine where invoices or expense reports may be routed for approval based on a policy, etc.

FIG. 2 is a capture processing method 200 according to an embodiment of the invention. In 210, the capture module 120 may receive an invoice. For example, this may be a paper invoice scanned into the capture processing system 110, an electronic invoice, or an invoice entered in some other way. (Note that electronic invoices are also discussed in greater detail below.) In 220, the OCR module 140 may receive the captured invoice from the capture module 120 and may perform OCR processing on the invoice. In 230, the processing module 130 may receive the OCR processed invoice from the OCR module 140 and may populate fields in an expense report or other dataset. In 240, the processing module 130 may present the report to a user for review. For example, the report may be displayed on a graphical user interface (GUI) on a user computer 160 in communication with the capture processing system 110 and/or a computer of the capture processing system 110 itself. In 250, the processing module 130 may receive user approval, and the process 200 may end with the data in the expense report being ready for further processing by the capture processing system 110 or some other system. For example, the expense report may be sent to an accounting computer or user and may be used to approve and/or pay the invoice. If the user does not approve in 250, the user may make changes to the fields and the processing module 130 may process these changes and populate the fields in 230. As noted above, the changes may include adding new fields and/or associating certain data with certain fields, so that future instances of the process 200 may automatically process the data in a manner similar to that suggested by the user.

The capture processing system 110 may capture invoice data received via email or some other electronic communications medium. The capture processing system 110 may be able to capture the invoice data whether the invoice is in a processing ready format (e.g., electronic data interchange (EDI)) or not. For example, a supplier may send an email with an image of an invoice to the capture processing system 110. This may be done as part of the ordinary course of business, as many suppliers they send an image of the invoice to their buyer. In such a case, an email address which is associated with the capture processing system 110 may be provided to suppliers as an address to which to send invoices. In other cases, an invoice may be forwarded by its recipient to the capture processing system 110. The invoices may be received via email, and the capture processing system 110 may identify a buyer for which the invoice is intended. For example, the capture module 120 may examine the email and detect identifying data in the email which may associate the email with a particular buyer. Once the buyer is known, the OCR module 140 may process the image to place its data in a computer readable format. The processing module 130 may then extract the invoice data from the OCR processed data. Multiple techniques may be used to determine the correct data to capture for the invoice. For example, techniques may include vendor lookups, invoice number formatting, PO number recognition, etc. The invoices may be processed through an automated workflow by the processing module 130, which may determine how much user verification needs to be done on the captured data. This automated workflow may allow the processing module 130 to verify that all data is correct and can be configured based on individual buyer interests. Once all data is captured and verified, it may be integrated into an invoice processing system, which may allow a buyer to approve and pay the invoice.

FIG. 3 is an email capture processing method 300 according to an embodiment of the invention. In 310, the capture module 120 may receive electronic data which may include an invoice. For example, the received data may be in the form of an email. An email address may have been linked to the capture processing system 110 and distributed to suppliers, so that invoices may be routinely sent to the capture processing system 110 by the suppliers. In 320, the capture module 120 may examine the email and identify its intended recipient. For example, the capture module 120 may read the destination email address and determine a user, department, client, etc. associated with that email address, for example by looking the address up in a database. In 330, the capture module 120 may extract an invoice from the electronic data. This invoice may be in any format. It may be included in the body of the email and/or it may be an attachment. In 340, the OCR module 140 may receive the captured invoice from the capture module 120 and may perform OCR processing on the invoice. In 350, the processing module 130 may receive the OCR processed invoice from the OCR module 140 and may populate fields in an expense report or other dataset. In 360, the processing module 130 may present the report to a user for review. For example, the report may be displayed on a graphical user interface (GUI) on a user computer 160 in communication with the capture processing system 110 and/or a computer of the capture processing system 110 itself. In 370, the processing module 130 may receive user approval, and the process 300 may end with the data in the expense report being ready for further processing by the capture processing system 110 or some other system. For example, the expense report may be sent to an accounting computer or user and may be used to approve and/or pay the invoice. If the user does not approve in 370, the user may make changes to the fields and the processing module 130 may process these changes and populate the fields in 350. As noted above, the changes may include adding new fields and/or associating certain data with certain fields, so that future instances of the process 300 may automatically process the data in a manner similar to that suggested by the user.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method comprising:
performing processing associated with receiving, with a capture module in communication with a processor, data;
performing processing associated with converting, with an optical character recognition (OCR) module in communication with the capture module and the processor, the data into machine readable data;
performing processing associated with extracting, with a processing module in communication with the OCR module and the processor, relevant data from the machine readable data; and
performing processing associated with populating, with the processing module, a field in a report with the relevant data.

2. The method of claim 1, further comprising:
performing processing associated with sending, with the processing module, the report to a user;
performing processing associated with receiving, with the processing module, a change to the field from the user; and
performing processing associated with populating, with the processing module, the field in the report with the change.

3. The method of claim 1, wherein the performing processing associated with receiving, with the capture module, data comprises:
performing processing associated with receiving, with the capture module, a scanned image of a physical document.

4. The method of claim 1, wherein the performing processing associated with receiving, with the capture module, data comprises:
performing processing associated with receiving, with the capture module, electronic data; and
performing processing associated with extracting, with the capture module, the data from the electronic data.

5. The method of claim 4, wherein the electronic data is an email.

6. The method of claim 1, further comprising:
performing processing associated with identifying, with the capture module, an entity associated with the data.

7. The method of claim 6, wherein the entity is an email recipient.

8. The method of claim 1, wherein the data is an invoice.

9. The method of claim 1, wherein the report is an expense report.

10. The method of claim 1, further comprising:
performing processing associated with sending, with the processing module, the report to a computer for further processing.

11. The method of claim 1, wherein the data is arranged in an arbitrary format.

12. The method of claim 1, wherein performing processing associated with extracting, with the processing module, relevant data from the machine readable data comprises:
performing processing associated with applying, with the processing module, a policy to determine which data from the machine readable data is the relevant data.

13. The method of claim 1, wherein performing processing associated with populating, with the processing module, a field in a report with the relevant data comprises:
performing processing associated with applying, with the processing module, a policy to identify a field to populate.

14. The method of claim 2, wherein performing processing associated with sending, with the processing module, the report to a user comprises:
performing processing associated with applying, with the processing module, a policy to identify the user.

15. A system comprising:
a processor;
a capture module in communication with the processor configured to perform processing associated with receiving data;
an optical character recognition (OCR) module in communication with the capture module and the processor configured to perform processing associated with converting the data into machine readable data; and
a processing module in communication with the OCR module and the processor configured to:
perform processing associated with extracting relevant data from the machine readable data; and
perform processing associated with populating a field in a report with the relevant data.

16. The system of claim 15, wherein the processing module is further configured to:
perform processing associated with sending the report to a user;
perform processing associated with receiving a change to the field from the user; and
perform processing associated with populating the field in the report with the change.

17. The system of claim 15, wherein the capture module is configured to perform processing associated with receiving data by:
performing processing associated with receiving a scanned image of a physical document.

18. The system of claim 15, wherein the capture module is configured to perform processing associated with receiving data by:
performing processing associated with receiving electronic data; and
performing processing associated with extracting the data from the electronic data.

19. The system of claim 18, wherein the electronic data is an email.

20. The system of claim 15, wherein the capture module is further configured to:
performing processing associated with identifying an entity associated with the data.

21. The system of claim 20, wherein the entity is an email recipient.

22. The system of claim 15, wherein the data is an invoice.

23. The system of claim 15, wherein the report is an expense report.

24. The system of claim 15, wherein the processing module is further configured to:
perform processing associated with sending the report to a computer for further processing.

25. The system of claim 15, wherein the data is arranged in an arbitrary format.

26. The system of claim 15, wherein the processing module is configured to perform processing associated with extracting relevant data from the machine readable data by:
performing processing associated with applying a policy to determine which data from the machine readable data is the relevant data.

27. The system of claim 15, wherein the processing module is configured to perform processing associated with populating the field in the report with the relevant data by:
performing processing associated with applying a policy to identify a field to populate.

28. The system of claim 16, wherein the processing module is configured to perform processing associated with sending the report to a user by:
performing processing associated with applying a policy to identify the user.
